(19) United States
(12) Patent Application Publication
(10) Pub. No.: US 2012/0050050 A1
(43) Pub. Date: Mar. 1, 2012

(54) ALARM SYSTEM FOR AN AIR CONDITIONER ASSEMBLY

(76) Inventors: Joseph Wojtowicz, Westland, MI (US); Saundra K. Wojtowicz, Westland, MI (US)

(21) Appl. No.: 13/286,621

(22) Filed: Nov. 1, 2011

Related U.S. Application Data
(63) Continuation-in-part of application No. 11/845,196, filed on Aug. 27, 2007.
(60) Provisional application No. 60/823,995, filed on Aug. 30, 2006.

(51) Int. Cl. G08B 21/00

(52) U.S. Cl. 340/626

(57) ABSTRACT

An alarm system for an AC assembly having an exterior located condenser supplied by a pressurized refrigerant system flowing between interior and exterior locations of a structure. A power source supplies an alarm panel at interior locations of the structure. A normally closed fluid pressure switch is electrically coupled between the power source and alarm panel and is maintained in an open and fluid communicating position upon detecting a continuous inlet fluid pressure. The pressure switch recloses upon sensing a decrease or loss of pressure, at which point a relay communicating closes to complete an electrical circuit between the power source and alarm panel. An alarm output in communication with the alarm panel responds to the closing of the relay to issue an alarm condition.

### CROSS-REFERENCE TO RELATED APPLICATIONS

This application is a continuation-in-part of U.S. patent application Ser. No. 11/845,196, filed Aug. 27, 2007, which claims the benefit of U.S. Provisional Patent Application Ser. No. 60/823,995, filed Aug. 30, 2006.

### FIELD OF THE INVENTION

The present invention discloses a security alarm system such as in use with residential and commercial air conditioning (AC) assemblies, the alarm incorporating detection circuitry monitoring the internal fluid pressure of a cooling system and in order to detect damage indicative of sectioning and removal of copper lines and/or external located condenser components associated with the air conditioner assembly.

### BACKGROUND OF THE RELEVANT ART

Air conditioning units are being pillaged by thieves for intent on harvesting the copper and other recycle-able metals that the air conditioner might contain. Among other elements within the air conditioner, the coils, the condenser and the compressor may contain copper which hold street value to the criminals. For example, the copper may be sold to a reseller, a junkyard or the like. In response, a number of alarm systems have been developed to counteract such incidences of theft. A vulnerability of such alarm systems includes the exposure, such as at external locations of an associated structure which is accessible by the thieves, of critical circuitry and components the deactivation or removal of which can often short circuit whatever associated alarm protocol is provided for warning others of the theft in progress.

### SUMMARY OF THE PRESENT INVENTION

The present invention discloses a security or alarm system for use with such as the outdoor portions of an air quality conditioning (cooling) system including such as window or pad supported condenser units. As will be described in further detail throughout the following detailed description, the alarm system monitors a fluid pressure of the refrigerant incorporated into the cooling system at an internal (presumably inaccessible to the thieves) location and issues an alarm output upon sensing pressure loss, this occurring either through a leak or break in any associated conduit line which is typical upon a thief having cut into the pressurized system in the attempt to remove the copper piping or the like.

It is an advantage of the present invention to provide such an alarm system with a first portion of the pressurized refrigerant system being located within a secure structure, such as the building being cooled by the air conditioning unit, as well as a second portion of the pressurized refrigerant system being located outside of the structure. The alarm system additionally provides for monitoring the pressure within the pressurized refrigerant system, such being fluidly coupled to the pressurized refrigerant system within the secure structure. A power source is communicated to the pressurized monitoring circuitry and operates to generate an alarm upon detecting a pressure drop across the pressurized refrigerant system.

Still further objects and advantages of the invention will become readily apparent to those skilled in the art to which the invention pertains upon reference to the following detailed description.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a schematic view of the alarm system according to an embodiment of the invention;

FIG. 2 is a wiring diagram according to an embodiment of the invention;

FIG. 3 is a wiring diagram according to another embodiment of the invention;

FIG. 4 is a schematic view of the alarm system according to a further embodiment; and

FIG. 5 is an associated wiring diagram corresponding to the embodiment of FIG. 4.

### DETAILED DESCRIPTION OF THE INVENTION

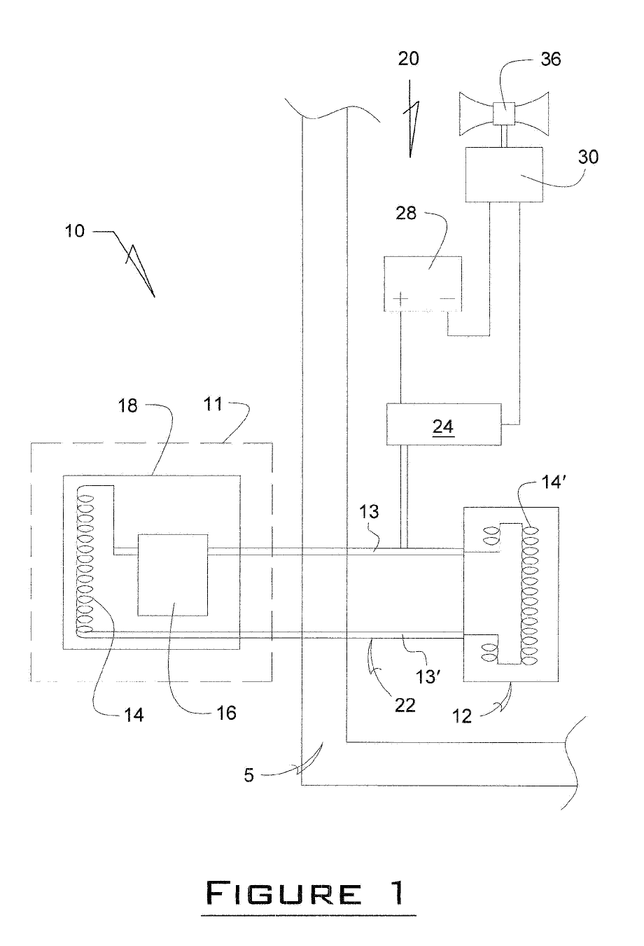

Referring to FIG. 1, an air quality or conditioning system is generally illustrated at 10 according to one non-limiting variant of the present invention. The conditioning system 10 includes an external component 11 typically located outside of a structure 5 being cooled, as well as an internal component 12 located within the structure 5.

Individual pairs of refrigerant lines are represented at 13 and 13′ and extend between the external 11 and internal 12 components in communication with respective pluralities of heat transfer coils 14 (associated with the external component), as well as additional coils 14′ (associated with the internal component). The coils 14 and 14′ include any of evaporator coils, condensing coils and the like.

A compressor 16 is incorporated into the external component 11 and in communication with selected refrigerant lines 13 and the coils 14. A condenser 18 defines a major unit of the external component 11 and encloses the coils 14 and compressor 16. Also, and while FIG. 1 shows refrigerant lines 13 and 13′ extending outside compressor 16, it is further contemplated that such refrigerant lines may be fully encapsulated within the compressor.

Refrigerant is provided within one or more of the refrigerant lines 13 and 13′, communicating coils 14 and 14′, compressor 16 and condenser 18 such that the refrigerant moves through the system in a generally closed loop fashion. For brevity, such elements will be generically referred to as generic elements as such will be recognized by one of ordinary skill in the art.

The refrigerant is provided within the refrigerant lines 13, coils 14, condenser 18, and compressor 16 at a defined pressure in order to internally pressurize the fluid system, see further at 22 in FIG. 1. It is further understood that any application specific refrigerant exhibiting a defined internal pressure can be used and the invention can be instituted and practiced at any suitable pressure level. That is, one of ordinary skill in the art can implement the invention across a variety of pressure levels upon consideration of the present disclosure and the invention should not be limited to any specific pressure.

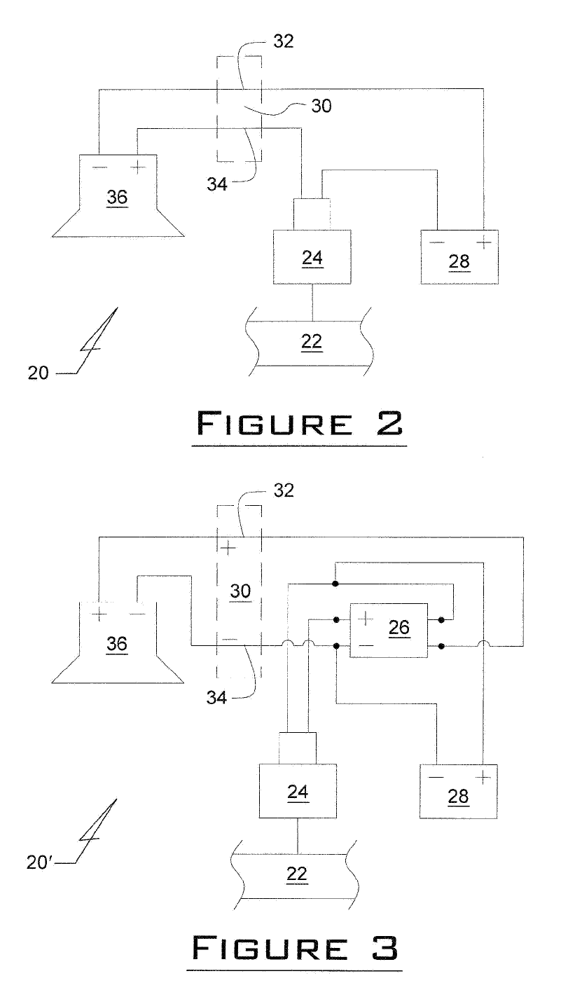

Referring additionally to FIG. 2 in cooperation with FIG. 1, an alarm is generally depicted at 20 and includes a pressure measurement device 24 connected to the internally pressurized system, schematically illustrated again at 22. The pressure measurement device 24 is designed and calibrated to detect when a pressure drop occurs within the pressure system 22 and, as described below, to provide for an alarm notification output. For clarity, embodiments to accomplish the foregoing will now be described; however, it will be appreciated that a broad range of embodiments will be recognized due to the present disclosure and the invention should not be limited thereby.

Referring again to FIGS. 1 and 2 the alarm system 20 includes a power source 28 and an output 30 thereof (such as an audible siren, flashing light or other output including an alarm signal transmitted wirelessly or on-line to a remote location), the alarm output 30 also being in communication with the pressure measurement device 24. In a preferred embodiment, the pressure measurement device 24 is a normally closed pressure switch which is defined as a switch which is normally open when pressure is detected at an inlet side, thus permitting pressurized fluid flow to nominally pass therethrough, the pressure switch subsequently reclosing upon sensing a loss in pressure, this further being indicative of cutting or other failure in the integrity of the associated fluid lines. Once the normally closed pressure switch 24 (re)closes, a circuit between the power source 28 and output 30 is completed (closed), this resulting in a voltage drop across an output 30.

In an alternative embodiment shown in FIG. 3, alarm 20′ includes pressure measurement device 24, a relay 26, power source 28 and output 30. In this embodiment, pressure measurement device 24 is a normally open pressure switch that opens when a pressure drop is witnessed thereacross, and, for at least that reason, the disclosure hereof includes relay 26 for selectively coupling power source 28 to output 30. In an embodiment, the relay 26 is arranged such that the voltage drop at output 30 is increased when a pressure drop is detected by pressure measurement device 24, which therefore closes and completes the circuit.

In either of the above embodiments, the output 30 is simply the voltage drop across a first wire 32 and a second wire 34 and such as will be greater when the pressure measurement device 24 detects a pressure drop thereacross. In a preferred embodiment, an output alarm device 36 is connected to the output 30 and may include such as a siren, a conventional alarm system, a telephone dialer, or the like. By additional example, this contemplates the output 30 being hardwired into a conventional home alarm system and work in conjunction therewith.

As further shown in FIG. 1, the pressure measurement device 24 is mounted to the pressure system 22 at the internal component 12 of the cooling unit 10 and is contained within the secure structure 5 being cooled. As such, the portion of the alarm 20 that monitors the internal pressure and activates the alarm upon detecting a pressure drop is separated from the (typically exteriorly located) components it is protecting, again including refrigerant lines 13 and 13′, coils 14 and 14′, compressor 16, and condenser 18, which are ordinarily located within the external component 11 of the overall conditioning system 10. Accordingly, and by mounting the alarm 20 and associated pressure measurement device 24 inside the structure 5, the alarm may not be readily circumvented by potential thieves.

It will be appreciated that the invention described herein will detect when the pressure system 22 is interrupted. Interruptions, for example, may occur due to theft of the unit or associated fluid lines and whereupon refrigerant is evacuated from the pressure system 22 as a result, as well as resulting from a non-theft incident and in which the volume and pressure of the internal refrigerant becomes low due to a leak in the system or the like.

It will be appreciated that various type of refrigerant may be used and the invention should not be limited to any specific type of refrigerant. In an embodiment, the refrigerant may be Freon or a composite having FREON® therein.

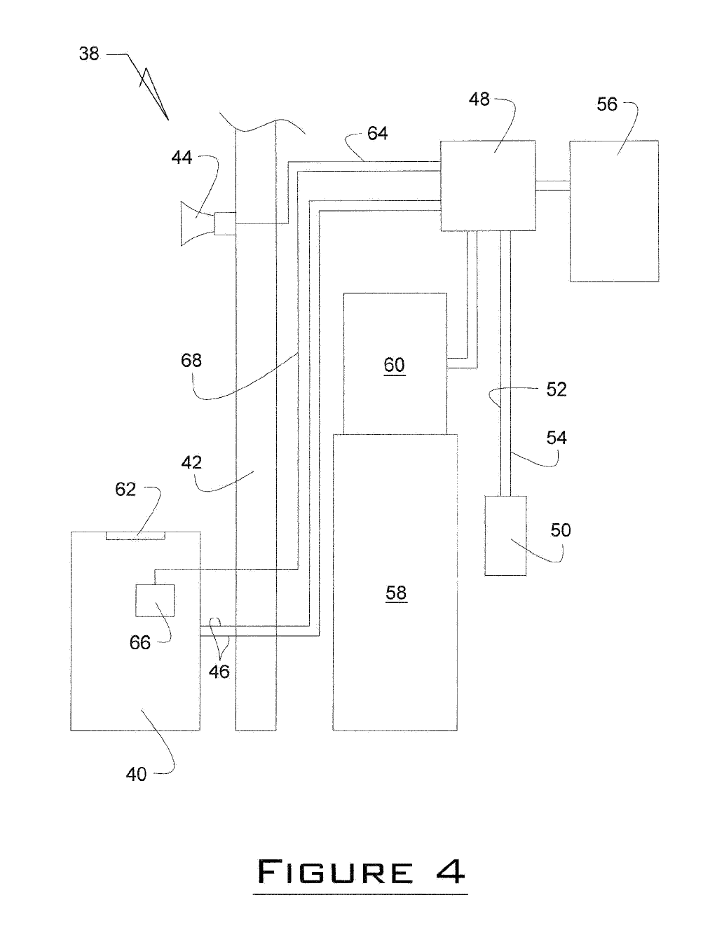

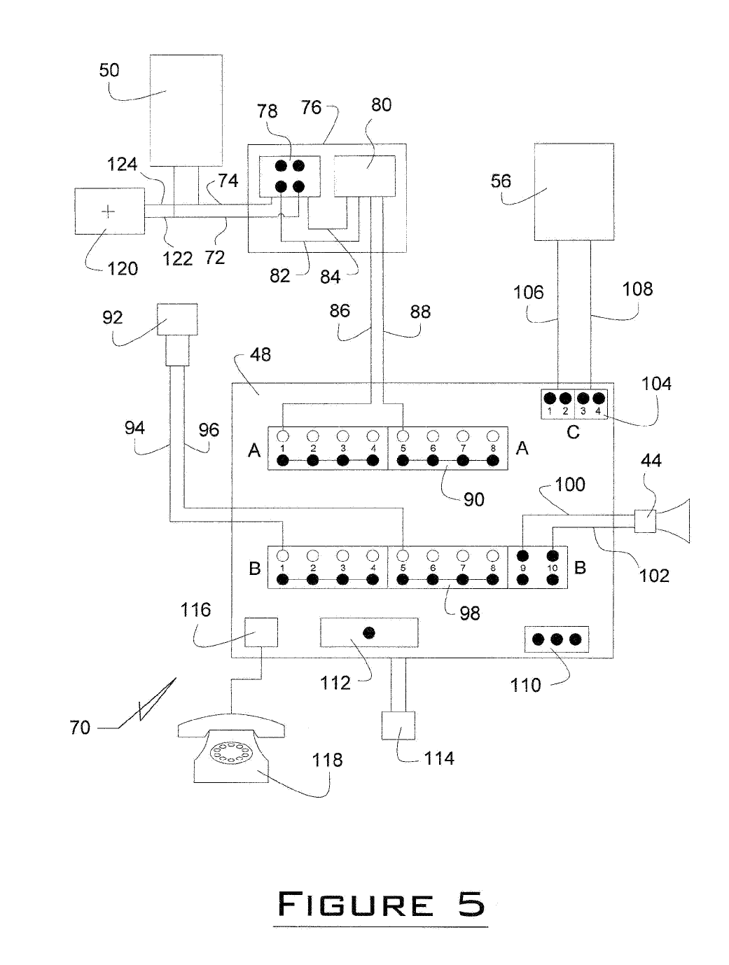

Referring now to FIGS. 4 and 5, an alarm system and associated wiring diagram are illustrated of an alarm system, generally at 38, according to a further embodiment. A combined outside compressor and power monitoring relay is collectively represented by exterior subassembly 40 at a generally outside location relative to a proximately located structure (see wall 42 separating exterior and interior locations similar to that previously depicted in FIG. 1). A weatherproof indoor/outdoor siren is further represented at 44 mounted to an exterior location of the wall 42.

A pair of pressurized conduit lines are commonly illustrated at 46 and extend from the outside subassembly 40, through the wall 42 and to an interiorly located alarm panel 48. A power supply 50 (also interiorly located) supplies power to the alarm panel 48, such as via positive and negative wires 52 and 54. The alarm panel 48 is typically mounted in series with an existing security alarm panel 56, it being further understood that both panels 48 and 56 are, in certain original installations, capable of being integrated together.

An interior air handling unit 58 is illustrated, such as including a conventional interior located furnace exhibiting a typical blower subassembly which is capable of working in cooperation with the exteriorly positioned condenser for providing interior air conditioning. Mounted atop the air handling unit 58 is a further collective subassembly depicted at 60 and which includes the arrangement of inner fluid coils and normally closed pressure switch (reference again being made to corresponding coils 14 and normally closed pressure switch 24 in the alternate variant of FIG. 1).

Additional features include the provision of a tilt/tamper switch 62, such as mounted without limitation to the top inside of the condenser housing, and which triggers the alarm (panel 48 and connected siren 44 via output line 64), in the instance of any attempt to disassemble or remove the condenser unit cover. Also provided is a 480 Volt monitoring relay attaching to a contactor (see at 66 in FIG. 5) within the condenser 40 (this defining part of the overall subassembly including the relay as further described in FIG. 5) in order to monitor the electricity to the unit and to further signal the internally located alarm panel 48, such as via further communicating line 68, in the event of an attempt to shut off power to the unit.

With reference finally to FIG. 5, a wiring diagram corresponding to the variant of FIG. 4 is generally depicted at 70 and again references at 48 the alarm panel which is typically installed as part of the present invention in combination with existing security alarm panel further depicted at 56. Power source (such as 220V) is again shown at 50 and extends, via wires 72 and 74 (corresponding to lines 52 and 54 in FIG. 4) to a further subassembly 76 incorporating a contactor 78 (such that the wires 72 and 74 extend to input locations of the contactor 78) and which, as previously described, can be located within the interior of the condenser for monitoring the power supply delivered to the unit.

A power monitor relay is further depicted at 80 and is communicated by output lines 82 and 84 extending from the contactor 78. The relay 80 in turn outputting, via lines 86 and 88, to selected locations of a first terminal strip 90 contained within the panel 48.

A normally closed pressure switch is further depicted at 92 and which is communicated, via wires 94 and 96, to further input locations of a second terminal strip 98, the same including further output wires 100 and 102 associated with output siren (see as also previously depicted at 44 in FIG. 4). A third (smaller) terminal strip 104 provides output, via wires 106 and 108 to separately connected existing alarm panel 56.

Additional features associated with the alarm panel include on/off switch 110 and test button 112. A 12 V transformer is further represented at 114 in communication with the panel 48.

The normally closed pressure switch and alarm protocol operates in the variant of FIG. 4 in substantially the same manner as previously described in the variant of FIG. 1 and by which a sensed loss of pressure along the fluid conduit lines 46 (such as indicated of an attempt to section the lines from an exterior location) causes the relay 80 to close a circuit with the alarm panel 48 (via output lines 86 and 88 to terminal strip 90) and the panel 48 in turn to activate siren 44 via further output lines 100 and 102 extending from terminal strip 98.

The configuration of the normally closed pressure switch 92 is further such that the alarm only triggers in the event that the refrigerant (conduit) lines are cut and does not provide a false signal in the instance of a pressure variation resulting only from uneven fluid pressure or flow within the conduit lines which may not be representative of an attempt to cut the lines. Also, the present design is constructed so that the alarm will trigger in the instance of any interruption of power to the AC unit (e.g. including outside condenser).

It is also envisioned that multiple exterior located condenser units (i.e. up to four) can be connected to a single alarm panel 48. The alarm panel 48 can be further configured such that it communicates directly with the existing alarm panel 56 (such as additional to the siren output described above) and further in order to notify the existing alarm company (via the communication link established between the existing panel) in the event of an alarm condition.

Additional features include the incorporation of a phone dialer in the alarm panel 48 (see as depicted at 116) which can dial a given number of reaching a designated phone 118 if the alarm system is triggered. A separate portable battery source (see at 120 in FIG. 5) can also be provided via wires 122 and 124 tapping into contactor wires 72 and 74, respectively, and in order to operate the alarm system in the instance of loss of utility power to the facility.

Having described my invention, other and additional preferred embodiments will become apparent to those of ordinary skill in the art to which it pertains, and without departing from the scope of the appended claims.

I claim:

1. An alarm system for an air conditioning assembly including an exterior located condenser which is supplied by a pressurized refrigerant system flowing between interior and exterior communicating locations of an associated structure, said alarm system comprising:
an electrical power source supplying an alarm panel at interior locations of the structure;
a normally closed fluid pressure switch communicating with at least one conduit line associated with said pressurized refrigerant system, said pressure switch being in communication with said alarm panel and opening in a fluid communicating position when detecting a continuous inlet fluid pressure, said fluid pressure switch reclosing upon sensing a decrease or loss of pressure;
a relay communicating with said pressure switch and alarm panel and, upon closing of said fluid pressure switch, in turn closing to complete an electrical circuit between said power source and said alarm panel; and
an alarm output in communication with said alarm panel and positioned at either or both of interior and exterior locations which, upon said relay closing, issues an alarm condition.

2. The alarm system as described in claim 1, said relay further comprising a 480V monitoring relay.

3. The alarm system as described in claim 1, further comprising a tilt/tamper switch adapted to being mounted to an inside location of the condenser and communicating with a contactor in turn connected in series to said relay in order to issue an alarm condition in the instance of an attempt to remove an outer housing of the condenser.

4. The alarm system as described in claim 1, said alarm panel further comprising a first terminal strip receiving an output from said relay, a second terminal strip receiving an output from said normally closed pressure switch and in turn issuing said output to a siren, and a third terminal strip adapted to be wired in communication with a further alarm panel associated with an existing alarm.

5. The alarm system as described in claim 1, further comprising a phone dialer incorporated into said alarm panel for contacting an outside phone in the event of an alarm condition.

6. The alarm system as described in claim 1, further comprising a portable back up power supply wired in parallel with said electrical power source.

7. The alarm system as described in claim 1, further comprising an on/off switch associated with said alarm panel.

8. The alarm system as described in claim 1, further comprising a test button associated with said alarm panel.

9. The alarm system as described in claim 4, further comprising an output signal sent from said third terminal strip to said further existing alarm panel in the instance of an alarm condition.
